(19) United States
(12) Patent Application Publication
(10) Pub. No.: US 2009/0232524 A1
(43) Pub. Date: Sep. 17, 2009

(54) DEVELOPER SUPPLY DEVICE, DEVELOPER SUPPLY CONTROL METHOD, AND DEVELOPER SUPPLY CONTROL PROGRAM

(75) Inventors: Naoki Takahashi, Kyoto (JP); Kazumasa Hayashi, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/278,301

(22) PCT Filed: Feb. 5, 2007
(86) PCT No.: PCT/JP2007/051902

§ 371 Date: Aug. 5, 2008

(30) Foreign Application Priority Data
Feb. 7, 2006 (JP) 2006-029393

(51) Int. Cl. G03G 15/08

(52) U.S. Cl. 399/27

(57) ABSTRACT

An image forming device in which the toner density of a two-component developing device can be stably controlled in printing a one-page image and the frequency of interruption of even printing a series of pages can be decreased as less as possible. The number of pixels of the image relevant to the development counted during the printing and the toner consumption is estimated from other image information, and the amount of toner corresponding to the consumption is supplemented. In this supplement, the count is acquired at an intermediate time of the one-page printing, the toner consumption is estimated, and the toner is supplemented during the printing after the intermediate time. Thereby, toner supplement can be performed ahead of its schedule, and a variation of the toner density can be prevented correspondingly.

### TECHNICAL FIELD

The present invention relates to an image forming device, such as a copier or a printer, using a developer. In particular, the present invention relates to a technology where a consumed toner is supplemented to a development device (said supplement to a development device also referred to as a ‘supply’) and the toner concentration (a ratio of the toner in a two-component developer) within the development device is controlled at a standard within a predetermined range with regard to the development device that makes an electrostatic latent image formed on an image supported body, such as a photoreceptor, visible using a two-component developer composed of a toner and a magnetic carrier (hereafter, simply referred to as ‘carrier’).

### BACKGROUND ART

In an electrophotographic device (an image forming device using an electrophotographic method) using a two-component developer composed of a toner and a carrier, a mixture ratio affects an output image (an image formed and rendered by a device) and an optical density (an optical density of the output image is referred to as an image density, and the optical density and the image density are simply referred to as density, as well). Therefore, in order to stabilize the density of the output image, it is essential to supplement a toner with an amount equivalent to that consumed via printing (not limiting to printing of letters but figures and any other general images) to a development device and to control the toner concentration within the developer at a predetermined standard. Then, a conventional toner supply unit for this control is described, for example, in Patent Literature 1.

The conventional toner supply unit described in the Patent Literature 1, in order to correct a developer concentration within the development device, which has been changed due to the development of the electrostatic latent image; i.e., in order to control a toner amount to be supplied to the development device, is designed to count (integrate) a level of an output signal of the image signal processing circuit per pixel (this means is referred to as a first developer concentration control means).

In the image forming device in Patent Literature 1, as shown in FIG. 1 and FIG. 2 of said literature, the output signal level of the image data entered as information for image formation is integrated (this integrated number is referred to as the number of video counts), and the number is converted into the number of video counts and converted into toner usage based upon the number of video counts. Estimation of the consumption according to the toner usage and supplement of the toner to a development device are different from a direct detection of the actual toner concentration in the developer and the supplement of the toner based upon the detection. Since the supplement is absolutely according to the estimation, it is described in Patent Literature 1 that if a toner supplement amount from a toner supplementing tank to the development device or a toner consumption from a development device is changed from an estimated value, or if the performance of a consumption system or a supplement system is fluctuated, the toner concentration in the developer within the development device, i.e., a mixture ratio of the toner particles to carrier particles is gradually shifted from an initially-set value (a defined value), and it is pointed out in Patent Literature 1 that if said shift is left uncorrected, the toner concentration greatly deviates from a tolerable range of the initially-set value.

In the image forming device described in said literature, a second developer concentration control means is established, and is designed to operate the second developer concentration control means at predetermined timing. For example, every time one copy operation in said device is completed or every time the number of copies achieves a predetermined number, or every time the number of video counts achieves a predetermined number, and to form an image for reference on a photoreceptor drum, and a light from a light source, such as an LED, is irradiated to a patch-state reference toner image (referred to as a density patch) obtained via said operation, and a reflected light is received by a photoelectric transducer. At this time, since the output signal of the photoelectric transducer corresponds to the density of the reference toner image, finally the output signal corresponds to the toner concentration in the two-component developer within the development device.

When the defined toner concentration (toner concentration in the initially-set value) of the developer is compared with the actual toner concentration within the development device, if the actual toner concentration of the developer detected by the photoelectric transducer is smaller than a defined value, i.e., if the toner is not sufficiently supplemented, the device supplements the deficiency of toner to the development device. In the meantime, if the actual toner concentration is greater than the defined value, i.e., if the toner is excessively supplemented, the excess toner amount in the developer is calculated based upon the output signal, and on the occasion of image formation according to a manuscript thereafter, the toner is supplemented so as to run down this excess toner amount, and for example, it is controlled such that a toner supplement per image is calculated so as to offset the excess toner amount and the toner is supplemented or an image is formed without supplementing the toner until the excess toner amount is consumed; in other words, an image is formed without supplementing any toner and the excess toner amount is consumed.

In Patent Literature 1, as described above, since the second developer concentration control means that forms a reference image, and detects its image density and controls the excess or deficiency about the toner supplement to the development device is established along with the first developer concentration control means that counts the level of the output signal of the image signal processing circuit per pixel, it is disclosed that the problem where the toner concentration of the developer within the development device, i.e., the mixture ratio of the toner particles to the carrier particles is gradually shifted from the initially-set value (the defined value) and the toner concentration is greatly shifted from the tolerable range of the initially-set value can be resolved.

[Patent Literature 1] Japanese Patent No. 3053951

### SUMMARY OF THE INVENTION

However, with the conventional image forming device, because the number of printed pixels in a page (the number of pixels where an image is formed (a toner is attached); also simply referred to as the number of pixels) is determined at the time of completion of printing a page, the toner supplement starts only thereafter. Then, if an image with a high printing rate (a coverage factor by color materials in the printed page), such as a solid image on an entire surface (an image whose coverage factor by color materials in an output image is close to 100% throughout the entire surface of the image), is printed, the toner concentration within the development device is drastically decreased; however, since the toner will be supplied after the completion of the printing on that page or during printing of a next page, the toner concentration remains as lower in the meantime. Therefore, an image with low density shall be printed on the next page after printing a solid image.

In other words, if the toner concentration under the normal condition is high or if a development device is sufficiently large-sized and the quantity of the developer is sufficiently large, because the toner amount within the development device is sufficient, the reduction in the toner concentration is also small and the degree of the reduction in the image density is also small. However, recently, under the circumstances where the device miniaturization has been advanced, because the toner amount existing within the development device becomes smaller, the fluctuation in the toner concentration at the time of printing is great, and especially when a solid image is printed, the density of a printed image in the next page shall be decreased.

Further, for the purpose of preventing this decrease, when the number of pixels of the printed image is detected and an image with the large number of pixels is printed, if the consumed toner is attempted to be supplemented before printing the next page so as to prevent the decrease in the toner concentration within the development device, the printing operation during the supplement shall be stopped during the supplement, and it causes the reduction in device productivity.

The present invention has been accomplished for resolving the problems in the prior art as described above, and has the objective of providing an image forming device where while the appropriate toner supply operation is conducted with appropriate timing even during the printing of an image on one page and the deterioration in the printing quality of the image is prevented, the interruption frequency of the printing operation in the meantime even in a series of printing where multiple pages are continuous is lessened as much as possible.

In order to accomplish the above-mentioned objective, the present invention is a developer supply device for supplying a developer to a development device on the occasion of forming an image, with regard to an image forming device comprising the development device that consumes the developer and forms an image onto paper or other recording medium, comprising: an image density counting means for counting image density of an image composed of multiple pixels per pixel; a developer consumption estimation means for estimating a developer consumption, which is an amount of the developer to be consumed during the development of the image, based upon the counted number of the image counted by the image density counting means, for an entire surface or a portion of image; and a developer supply means for supplying by supplementing a variable amount of developer to the development device; wherein the developer supply means supplements the developer with an amount base upon the estimated developer consumption for a portion of one surface, in the formation of an image on said surface during the period of image formation on said surface.

Further, the present invention may be a developer supply device supplying a developer to a development device on the occasion of forming an image, with regard to an image forming device comprising the development device that consumes the developer and forms an image onto paper or other recording medium, comprising: an image density counting means for counting image density of an image composed of multiple pixels per pixel; a developer consumption estimation means for estimating a developer consumption, which is an amount of the developer to be consumed during the development of the image, based upon the counted number of the image counted by the image density counting means, for an entire surface or a portion of image; an average developer consumption calculating means for calculating an average value of the developer consumption during a predetermined period in the past and an average developer consumption, which is another average value; and a developer supply means for supplementing a variable amount of developer to the development device; wherein the developer supply means supplements a developer with an amount based upon the average developer consumption calculated by the average developer consumption calculating means to the development device during the period of image formation on one surface, and the supplement of the developer after the formation on one surface is supplied by adjusting a difference between the developer consumption estimated by the developer consumption estimation means and an already-supplemented amount.

Further, the present invention is a control method of a developer supply for supplying a developer to a development device on the occasion of forming an image, with respect to an image forming device that comprises the development device to consume the developer and forms an image onto paper or other recording medium, comprising: an image density counting step for counting the image density of an image composed of multiple pixels per pixel; a developer consumption estimation step for estimating a developer consumption, which is an amount of developer to be consumed during the development of an image, based upon the counted value of the image counted in the image density counting step, for an image on one surface or a portion of the surface; and a developer supply step for supplying to supplement a variable amount of developer to the development device, wherein in the developer supplying step, the developer with an amount based upon the developer consumption estimated for a portion on one surface to the development device during a period of the image formation on the one surface in the image formation on one surface.

Further, the present invention is a control method of a developer supply for supplying a developer to the development device on the occasion of the image formation, with regard to an image formation device comprising the development device that consumes the developer and forms an image onto paper or other recording medium, comprising: an image density counting step for counting the image density of an image composed of multiple pixels per pixel; a developer consumption estimation step for estimating a developer consumption, which is an amount of the developer to be consumed during the development, based upon the counted value of the image counted by the image density counting means, for an image on one surface or an partial image; an average developer consumption calculating step for calculating an average value of the developer consumption during the past predetermined period and an average developer consumption, which is another average value; and a developer supply step for supplementing by supplying a variable amount of developer to the development device; wherein, in the developer supplying step, a developer with an amount based upon the average developer consumption calculated by the average developer consumption calculating means is supplemented to the development device during the period of image formation on one surface, and the supplement of the developer after the formation on one surface is supplied by adjusting a difference between the developer consumption estimated by the developer consumption estimation means and an already-supplemented amount.

In the present invention, since the adoption of this configuration enables the supplement of the consumed toner within the development device in an appropriate timing during printing of an image on one page, the fluctuation in the toner concentration during the printing of the image on one page can be moderated as much as possible. In particular, even in the case of a large quantity is consumed, the toner can be supplied without delay, the reduction in the image density on the occasion of continuous printing can be prevented, and in the meantime, the stop of a printing operation can be prevented.

### BRIEF DESCRIPTION OF THE DRAWINGS

FIG. 1 is a skeleton framework of the image forming device in the first embodiment.

FIG. 2 is a block diagram of a part of a toner concentration controlling unit.

FIG. 3 is a diagram for explaining an example of reference patterns.

FIG. 4 is a time chart at the time of intermittent printing operation.

FIG. 5 is a time chart at the time of continuous printing operation.

FIG. 6 is a flowchart of a toner supply operation.

FIG. 7 is a configuration diagram of a concentration sensor.

FIG. 8 is a block diagram showing another example of the configuration of an integrating unit in the toner concentration controlling unit.

FIG. 9 is a skeleton framework of the image forming device in the second embodiment.

FIG. 10 is a time chart in Embodiment 2.

FIG. 11 is a flowchart of the toner supply operation in Embodiment 2.

### DETAILED DESCRIPTION OF THE PREFERRED EMBODIMENTS

A first aspect in accordance with the present invention provides a developer supply device for supplying a developer to a development device on the occasion of forming an image, with regard to an image forming device comprising the development device that consumes the developer and forms an image onto paper or other recording medium, comprising: an image density counting means for counting image density of an image composed of multiple pixels per pixel; a developer consumption estimation means for estimating a developer consumption, which is an amount of the developer to be consumed during the development of the image, based upon the counted number of the image counted by the image density counting means, for an entire surface or a part of image; and a developer supplying means for supplying to supplement a variable amount of developer to the development device; wherein the developer supplying means supplements the developer with an amount base upon the estimated developer consumption for a portion of one surface, in the formation of an image on said surface during the period of image formation on said surface. For example, the developer consumption for a portion on one surface is estimated using a means for counting a time from the start of the image formation on the one surface to the partial image formation on said surface and a means for counting the number of lines.

Because of this configuration, in the formation of an image on one page, which is one surface, since the developer supply means is designed to supplement a developer, such as a toner, with an amount based upon the developer consumption estimated for a portion of the one surface, within a certain period of image formation on the one surface, for example, if the toner is supplemented at the time when printing of one-half of page in the printing operation on one page is completed, since the balance between the consumption and supplement of the toner is only the deficiency of the one-half page, the fluctuation in the toner concentration within the development device can be moderated by roughly one-half.

A second aspect in accordance with the present invention provides the developer supply device in the first embodiment of the present invention, further comprising a developer amount controlling means for controlling the supply of a developer by the developer supplying means, wherein the developer controlling means controls so as to supply the developer by the developer supplying means when the developer consumption estimated by the developer consumption estimation means exceeds a predetermined threshold value.

Because of this configuration, if the developer control means is designed to control the supply of the developer, such as a toner, by the developer supply means when the developer consumption estimated by the developer consumption estimation means exceeds a predetermined threshold value, a possibility where the toner supplement becomes excessive is moderated by preventing the supplement of the toner, for example, when the toner consumption is very low, and the toner supply stability can be improved by a precise toner supplement in the case that the toner supplement is required.

A third aspect in accordance with the present invention provides the developer supply device in the second embodiment of the present invention, wherein the developer amount controlling means further controls a correction for correcting an amount of the developer supplied by the developer supplying means so as to have the amount of the developer within the development device being a predetermined standard amount; obtains an aggregate value from the previous correction of the developer consumption estimated by the consumption estimating means every time the image formation for a portion of the one surface is completed and every time the formation on the one surface is completed; and controls the correction when the obtained aggregate value exceeds a predetermined threshold value.

Because of this configuration, an aggregate value of the developer consumption estimated by the developer consumption estimation means is compared to a first threshold value every time an image formation on a part of the one page, which is one surface, is completed, or is compared to a second threshold value every time the formation on the surface is completed, and when the aggregate of the estimated developer consumption exceeds the first threshold value or the second threshold value, if it is designed to correct the toner amount to be supplied by the developer supply means so as to have the amount of the developer, such as a toner within the development device, to be a standard value, for the toner supply in the third embodiment of the present invention, the stability can be further improved by a predetermined adjustment after an image formation on one page.

A fourth aspect in accordance with the present invention provides a developer supply device supplying a developer to a development device on the occasion of forming an image, with regard to an image forming device comprising the development device that consumes the developer and forms an image onto paper or other recording medium, comprising: an image density counting means for counting image density of an image composed of multiple pixels per pixel; a developer consumption estimation means for estimating a developer consumption, which is an amount of the developer to be consumed during the development of the image, based upon the counted number of the image counted by the image density counting means, for an entire surface or a portion of image; an average developer consumption calculating means for calculating an average value of the developer consumption during a predetermined period in the past and an average developer consumption, which is another average value; and a developer supplying means for supplementing a variable amount of developer to the development device; wherein the developer supplying means supplements a developer with an amount based upon the average developer consumption calculated by the average developer consumption calculating means to the development device during the period of image formation on one surface, and the supplement of the developer after the formation on one surface is supplied by adjusting a difference between the developer consumption estimated by the developer consumption estimation means and an already-supplemented amount.

Because of this configuration, since the developer supply means supplements a certain amount of developer, such as a toner, based upon the average developer consumption calculated by an average developer consumption calculating means within a period of image formation on one surface, the average developer consumption of the printing history in the past is all reflected, for example, because the accuracy of the development consumption on the occasion of printing a specified image is very good, the toner can be supplemented with an appropriate amount in the middle of the printing operation on one page, and an error between the excess and deficiency of the toner amount in the meantime can be very low. Further, since the developer supply means is designed to supply a toner by adjusting a difference between a developer consumption estimated by the developer consumption estimation means and the already-consumed amount in the supplement of the developer after the image formation on the one surface, even if there is an excess or deficiency in the toner amount to be supplemented for the printing on one surface associated with an error, the excess or deficiency can be appropriately corrected after printing the one surface. Then, these are combined, and the fluctuation in the toner concentration within the development device can be moderated at very low even during printing and even after printing.

A fifth aspect in accordance with the present invention provides the developer supply device in the fourth embodiment of the present invention, wherein the average developer consumption calculating means calculates at least one of an average value of the developer estimated consumptions in the past estimated by developer consumption estimation means in the past image formation and an average value only during the predetermined recent period, as the average developer consumption.

Because of this configuration, since the average developer consumption calculating means calculates, for the developer estimated consumption estimated by the developer consumption estimation means in the past image formations, at least one of an average value of the consumptions in the past and at least one of the average values only during the predetermined recent period is set as the average developer consumptions, and an average value can be simply and easily calculated.

A sixth aspect in accordance with the present invention provides the developer supply device in the fourth embodiment of the present invention, wherein the average developer consumption calculating means acquires an average value of the past developer estimated consumption in the past image formation estimated by the developer consumption estimation means and an average value only during the predetermined recent period, and assesses the average developer consumption by varying a ratio to weight between each other according to the degree of fluctuation in these values, based upon the average values.

Because of this configuration, since the average developer consumption calculating means is designed, for the developer estimated consumption estimated by the developer consumption estimation means in the past image formation, to acquired the average value of the past formations and an average value only during the predetermined recent period, and to assess an average developer consumption by varying a weighted ratio between each other according to the degree of fluctuation of these values based upon the average values, these two average values can be combined and used as occasions demands according to the use environment, such as an image forming device, and further optimization of the developer supply to the development device can be accomplished.

A seventh aspect in accordance with the present invention provides the developer supply device in the first or fourth embodiment of the present invention, wherein the development device comprises a developer agitating means for agitating the developer; and the developer supplying means completes or stops its supplying operation in the supplement of the developer to the development device before a predetermined time for suspending the agitation by the developer agitating means.

Because of this configuration, since the supply operation in the supplement of the developer to the development device is completed or stopped before a predetermined time when the developer agitating means stops agitation, it avoids the developer agitating means stopping the agitation without sufficient agitation of the developer supplied immediately before the stop of the agitation, and the agitated condition of the developer immediately after the start of a next development can become excellent.

A eighth aspect in accordance with the present invention provides the developer supply device in the first or fourth embodiment of the present invention, wherein the image density counting means counts the number of pixels to be developed.

Because of this configuration, since the image density counting means is designed to count the number of pixels to be developed, even in the case that the image density of pixels is binary, the image density per pixel can be easily and simply counted.

A ninth aspect in accordance with the present invention provides the developer supply device in the first or fourth embodiment of the present invention, wherein the image density counting means performs weighting with a predetermined coefficient according to the pattern of alignment of multiple pixels relating to the development, and counts the image density.

Because of this configuration, since the image density counting means is designed to weight and count the image density with a predetermined coefficient according to a type of pattern according to the alignment of multiple pixels relating to the development, the consumption of the developer including a quantity of the consumption due to the image shape can be assessed, and the developer consumption can be further precisely assessed.

A tenth aspect in accordance with the present invention provides the developer supply device in the ninth embodiment of the present invention, wherein the image density counting means counts the number of pixels to be developed and the number of pixels positioned at the end of a portion of an image where the pixels to be developed are continuously aligned, respectively.

Because of this configuration, since the image density counting means is designed to count the number of pixels to be developed and the number of pixels positioned at the end of an image where the pixels to be developed are successively aligned, respectively, a difference in the quantity of the consumption due to an image shape is obvious between the end of the image portion where the pixels to be developed are successively aligned and that of the inside of said portion, precise assessment of the developer consumption can be simply and easily conduced.

A eleventh aspect in accordance with the present invention provides the developer supply device in the first or fourth embodiment of the present invention, wherein the image density counting means counts the image density at the time or around the time of developing the pixels relating to the counting. For example, when image information is acquired from signals for exposure, a delay means for delaying the count according to the information is established in the image density counting means until the exposed portion achieves the vicinity of the development position.

Because of this configuration, counting is conducted not at the time of emission of a laser beam to the exposure position but at the time when the exposed portion is situated in the vicinity of the development position. Due to this design, when the printing operation is stopped in the middle due to abnormality, such as paper jam, even if an undeveloped region occurs after the exposure, the undeveloped region shall not be counted. Therefore, compared to the case of counting at the time of the emission of a laser beam to the exposure position, any excess toner supply can be eliminated.

A twelfth aspect in accordance with the present invention provides an image forming device comprising the developer supply device relating to the first or fourth embodiment of the present invention.

Because of this configuration, the image forming device where a fluctuation in the developer concentration within the development device is moderated can be realized.

A thirteenth aspect in accordance with the present invention provides a developer supply control method of a developer supply for supplying a developer to a development device on the occasion of forming an image, with respect to an image forming device that comprises the development device to consume the developer and forms an image onto paper or other recording medium, comprising: an image density counting step for counting the image density of an image composed of multiple pixels per pixel; a developer consumption estimation step for estimating a developer consumption, which is an amount of developer to be consumed during the development of an image, based upon the counted value of the image counted in the image density counting step, for an image on one surface or a portion of the surface; and a developer supply step for supplying to supplement a variable amount of developer to the development device, wherein in the developer supplying step, the developer with an amount based upon the developer consumption estimated for a portion on one surface to the development device during a period of the image formation on the one surface in the image formation on one surface.

Because of this configuration, the developer supply is designed such that a certain amount of developer, such as a toner, based upon the estimated developer consumption at least for a portion on one surface, in the image formation on one page, which is one surface, and for example, when a toner is supplemented at the time when one-half page of printing is completed in the printing operation of one page, the balance of the consumption and supplement of toner can be just for the deficiency of the one-half page, the fluctuation in the toner concentration within the development device can be moderated to roughly one-half compared to the conventional one.

A fourteenth aspect in accordance with the present invention provides the developer supply control method in the thirteenth embodiment of the present invention, further comprising a developer amount controlling step for controlling the supply of the developer by the developer supplying means, wherein in the developer amount controlling step, when the developer consumption estimated in the developer consumption estimation step exceeds a predetermined threshold value, it is controlled to supply the developer in the developer supply step.

Because of this configuration, since the developer amount control is designed to control so as to supply a developer, such as a toner, in the developer supply step when the developer consumption estimated in the developer consumption estimation step exceeds a threshold value, for example, the toner supplement at the time of minute consumption of the toner is prevented and a possibility where the supplement becomes excessive is prevented, and since a toner can be supplemented only when needed, the stability of the toner supply can be improved.

A fifteenth aspect in accordance with the present invention provides the developer supply control method in the fourteenth embodiment of the present invention, wherein, in the developer amount controlling step, correction control for correcting an amount of developer to be supplied by the developer supplying means is further conducted so as to have the amount of the development within the development device; the aggregate value of the developer consumption from the previous correction estimated in the developer consumption estimation step is acquired every time the image formation on a portion of the surface is completed and every time the formation on the surface is completed; and when the acquired aggregate value exceeds a predetermined threshold value, the correction control is conducted.

Because of this configuration, the aggregate [value] of the developer consumption estimated in the developer consumption estimation step is compared to a first threshold value every time the formation for a portion on one page of the image, which is one surface, is completed, and is compared to a second threshold value every time the formation on the one page is completed, and when the estimated developer consumption exceeds the first threshold value or the second threshold value, since the toner amount to be supplied in the developer supplying step is corrected so as to have the amount of a developer, such as a toner within the development device being a predetermined standard amount, a predetermined adjustment of the toner supply in the twelfth embodiment of the present invention is conducted again after the image formation on one page, and the stability can be further improved.

A sixteenth aspect in accordance with the present invention provides a developer supply control method of a developer supply for supplying a developer to the development device on the occasion of the image formation, with regard to an image formation device comprising the development device that consumes the developer and forms an image onto paper or other recording medium, comprising: an image density counting step for counting the image density of an image composed of multiple pixels per pixel; a developer consumption estimation step for estimating a developer consumption, which is an amount of the developer to be consumed during the development, based upon the counted value of the image counted by the image density counting means, for an image on one surface or an partial image; an average developer consumption calculating step for calculating an average value of the developer consumption during the past predetermined period and an average developer consumption, which is another average value; and a developer supply step for supplementing by supplying a variable amount of developer to the development device; wherein, in the developer supplying step, a developer with an amount based upon the average developer consumption calculated by the average developer consumption calculating means is supplemented to the development device during the period of image formation on one surface, and the supplement of the developer after the formation on one surface is supplied by adjusting a difference between the developer consumption estimated by the developer consumption estimation means and an already-supplemented amount.

Because of this configuration, since the developer supply is designed to supplement a certain amount of a developer, such as a toner, based upon the average developer consumption assessed in the average developer consumption calculating step during the image formation period on one surface, the average developer consumption is all reflected by the printing history in the past, and for example, since the accuracy of the developer consumption on the occasion of printing a defined image is excellent, an appropriate amount of toner can be supplemented in the middle of the printing operation on one page, and any error in the excess and deficiency of the toner amount in the meantime can be very low. Further, since the developer is designed to be supplied by adjusting a difference between the developer consumption estimated in the developer consumption estimation step and the already-supplemented amount in the supplement of the developer after the formation on said once surface, even if there is an excess or deficiency associated with an error in the toner amount to be supplemented for printing on one page, any excess or deficiency can be appropriately corrected after printing the one page. Then, these are combined, and the fluctuation in the toner concentration within the development device is moderated at very low even during printing and even after the printing

A seventeenth aspect in accordance with the present invention provides the developer supply control method in the sixteenth embodiment of the present invention, wherein in the average developer consumption calculating step, regarding the developer estimated consumptions in the past estimated in the developer consumption estimation step in the past image formation, at least one of an average value of these values in the past and an average value only during the predetermined recent period among them is calculated as the average developer consumption.

Because of this configuration, for the developer estimated consumption estimated in the developer consumption estimation step in the past image formation, since the average developer consumption calculation is designed to calculate an average value of these in the past and at least one of the average values only during the predetermined recent period as the average developer consumption, an average value can be simply and easily calculated.

A eighteenth aspect in accordance with the present invention provides the developer supply control method in the sixteenth embodiment of the present invention, wherein in the average developer consumption calculating step, for development estimated consumption estimated by developer consumption estimation step in the past image formation, an average value of those consumptions in the past and an average value of those consumptions only during the predetermined recent period are acquired, and the average developer consumption is assessed by varying a ratio to weight between each other according to the degree of fluctuation in these values, based upon the average values.

Because of this configuration, for the developer estimated consumption estimated in the developer consumption estimation step in the past image formation, since the average developer consumption calculation is designed such that an average value of the consumptions in the past and an averages value only during the predetermined recent period among them are acquired, and the average developer consumption is assessed by varying a ratio weighted between each other according to the degree of fluctuation in these values, these two average values can be combined and used according to a use environment, such as an image forming device, as occasions demand, and the developer supply to the development device can be further optimized.

A nineteenth aspect in accordance with the present invention provides the developer supply control method in the thirteenth or sixteenth embodiment of the present invention, wherein in the image density counting step, the image density is counted at the time or around the time of developing pixels relating to the counting.

Because of this configuration, the counting is conducted not at the time of emission of a laser beam to the exposure position but at the time when the exposed portion is situated in the vicinity of the development position. Due to this design, when a printing operation is stopped due to abnormality, such as paper jam, even if an undeveloped region occurs after the exposure, the undeveloped region shall not be counted. Therefore, compared to the case of counting at the time of emission of a laser beam to the exposure position, any excess toner supply can be eliminated.

A twentieth aspect in accordance with the present invention provides a developer supply control program for having the developer supply device executing the procedures in the developer supply control method according to the thirteenth or sixteenth embodiment of the present invention.

Because of this configuration, a developer supply device or an image forming device where a fluctuation in the concentration of the developer within a development device is moderated can be realized.

Hereafter, embodiments of the present invention will be described with reference to drawings.

### Embodiment 1

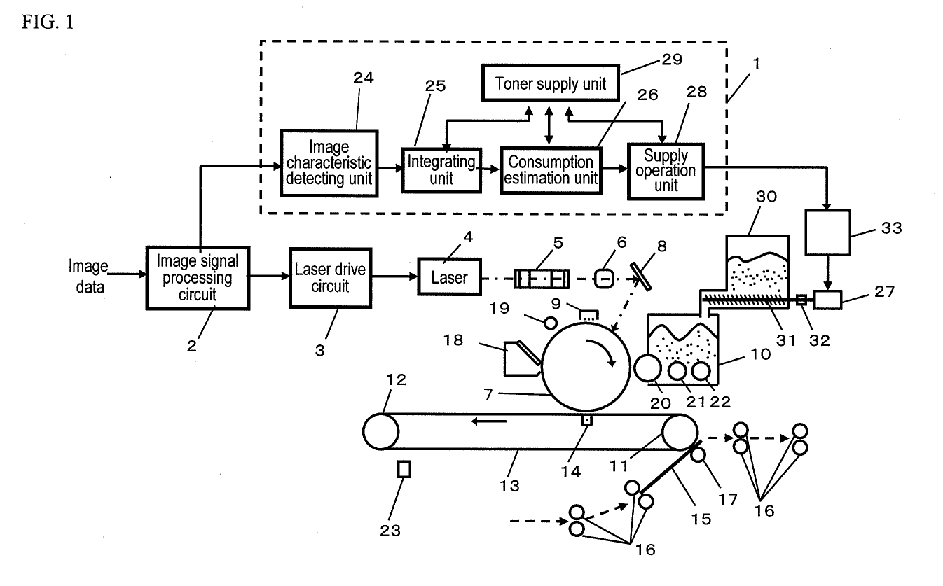

FIG. 1 shows a skeleton framework of an image forming device (referred to as this device) comprising a developer supply device and having a document copying function, as Embodiment 1 relating to the present invention.

In FIG. 1, this image forming device is roughly composed of an image signal processing unit for processing input image data, a laser optical system unit for guiding a light generated for the purpose of exposing a photoreceptor based upon image data processed by the image signal processing unit, an image forming unit for forming a visible image via an electrophotographic process, a toner supply mechanism unit, which is a developer supply device relating to the present invention for supplying a toner to a development device of the image forming unit, and a toner concentration control unit 1 for controlling the toner supply mechanism unit.

Each component is further constructed as described below.

The image signal processing unit is composed of an image signal processing circuit 2 for processing various corrections to be described below to input image data, and a laser drive circuit 3 for generating a laser drive signal based upon the processed image data.

The laser optical system unit is composed of a laser 4 that is emitted based upon the laser drive signal, a rotary polygonal mirror 5 that sweeps the laser beam emitted from laser 4, a lens system 6, such as a so-called f/θ lens, for guiding the swept light, and a mirror 8 for orientating the guided light onto a photoreceptor drum 7.

The image forming unit is for realizing the electrophotographic process, and with a central focus on the photoreceptor drum 7, this is composed of a charger 9 that uniformly charges the surface of the photoreceptor drum 7, a development device 10 that attaches a toner to the electrostatic latent image, which is obtained by exposure by the laser optical system unit after charging, a first transferring unit 14 that transfers a toner image, which has become a visible image, onto an intermediate transferring belt 13 supported by a support rollers 11 and 12, a conveyor roller 16 that conveys recording paper 15, a second transferring unit 17 that transfers the toner image on the intermediate transferring belt 13 onto the recording paper 15 conveyed by the conveyor roller 16, a cleaner 18 that removes any toner that is not transferred to the intermediate transferring belt 13 but remains on the photoreceptor drum 7, and an electricity removal unit 19 that removes a residual charge remaining on the photoreceptor surface.

Herein, the recording paper 15 where the toner image has been transferred is extracted to the outside of this device after heat and pressure are applied and fused by a not-shown fuser.

Further, the development device 10 is equipped with a development sleeve 20 that attaches the developer composed of a toner and a carrier contained inside onto the surface of the photoreceptor drum 7, and agitating screws 21 and 22 that circulate the developer within the development device 10 by agitating so as to uniform a mixture ratio of the developer.

Further, a density sensor 23 for detecting the density of the toner image on the intermediate transferring belt 13 is arranged in the vicinity of the intermediate transferring belt 13.

The toner concentration controlling unit 1 and the toner supply mechanism unit supply a toner to the development device 10 as occasions demand in order to prevent the reduction in the ratio of the toner within the development device 10 by the toner attaching to the photoreceptor drum 7 due to the development process.

Herein, the toner concentration controlling unit 1 is composed of an image characteristic detecting unit 24 for detecting characteristics of an image from the entered image data, an integrator 25 for integrating numerical value information detected by the image characteristic detecting unit 24 and storing the integrated information, a consumption estimation unit 26 for estimating a toner amount, which seems to be consumed based upon the numerical values stored in the integrator 25, a supply operation unit 28 for operating a drive time of a toner supply motor 27 required for supplementing a toner for an estimated consumption, and a toner supply controlling unit 29 for controlling these.

Further, the toner supply mechanism unit is composed of a conveyance screw 31 for conveying a toner from a toner reservoir 30 to the development device 10, the toner supply motor 27 for driving the conveyance screw 31, a gear sequence 32 for transmitting the rotation of the toner supply motor 27 to the conveyance screw 31, and a motor drive circuit 33 for transmitting a drive signal to the toner supply motor 27 only during the drive time calculated by the supply amount operation unit 28.

Furthermore, each component in the control unit is configured such that each operation is controlled by a not-shown CPU (microprocessor).

In the image forming device with the above-mentioned configuration, the operations will be described next.

First, the operations of the image formation will be described. At first, entered image data is entered into the image signal processing circuit 2. Herein, image processing required for correction of image screw, such as a screw correction, is applied. The image signal processing circuit 2 transmits the processed image data to the laser drive circuit 3 in a latter part and the image characteristic detecting unit 24.

Herein, the laser drive circuit 3 generates a laser drive signal for emitting the laser 4 based upon the processed image data. The laser 4 emits a light based upon the drive circuit generated by the laser drive circuit 3. Then, the emitted light scans the surface of the photoreceptor drum 7 via the rotary polygonal mirror 5, the lens system 6 and the mirror 8.

At this time, the photoreceptor drum 7 rotates in the arrow direction shown in the diagram with a predetermined timing.

Subsequently, the electrophotographic process in the image formation will be described in order.

First, the charger 9 charges the surface of the photoreceptor drum 7 with uniform potential.

Next, the surface of the photoreceptor drum 7 charged to the uniform potential is scanned with a light irradiated form the laser optical system unit, and exposed, and an electrostatic latent image corresponding to the processed image data is formed.

After that, the development device 10 using a two-component developer where toner particles and carrier particles are mixed attaches a toner to the electrostatic latent image on the photoreceptor drum 7 and makes the image visible.

Herein, inside the development device 10, rotation of the agitation screws 21 and 22 results in the uniformly-blended toner and carrier.

Due to the processes up to this point, a toner image corresponding to the processed image data is formed on the surface of the photoreceptor drum 7.

In the meantime, the support rollers 11 and 12 have started driving according to the exposure timing. Then, when the support rollers 11 and 12 are driven and rotate on their axes, respectively, the suspended intermediate transferring belt 13 rotates in the arrow direction led by the autorotation.

In the above-mentioned state, the first transferring unit 14 transfers the toner image on the photoreceptor drum 7 onto the rotating intermediate transferring belt 13.

Next, the second transferring roller 17 transfers the toner image on the rotating intermediate transferring belt 13 onto the conveying recording paper 15 by matching the timing by the conveyor roller 16. Since the toner image transferred onto the recording paper 15 is merely mounted onto the recording paper 15 at this point, it is heated and welding by a not-shown fuser then, and after this is fused, it is discharged to the outside of this device.

Then, the cleaner 18 removes any residual toner remaining on the photoreceptor drum 7 after the transfer. Then, the electricity removal unit 19 removes any residual charges on the photoreceptor drum 7, and a series of electrophotographic processes are completed.

Furthermore, although an example of a monochromatic image forming device is used and described here, in the case of a multicolor image forming device or a color image forming device, process elements including the photoreceptor drum and the development device are arranged by the number of the color component, and each color toner image is superimposed onto the intermediate transferring belt 13 and an image shall be formed.

Next, a toner supply movement in this device will be described.

The image data processed by the image signal processing circuit 2 is entered into the image characteristic detecting unit 24, as well. Then, the image characteristic detecting unit 24 detects characteristics of the image based upon the entered/processed image data. Specifically, the number of pixels to be printed (the number of pixels to be printed, i.e., to be developed; simply referred to as the number of pixels), the number of edges and a signal matched with a predetermined pattern (the number of these signals is referred to as the pattern matching number) are transmitted to the integrating unit 25. The pixel to be printed can be defined based upon the drive signal of the laser 4.

Herein, the number of edges is the number of sides to be an edge among the four sides of one pixel whose external form is rectangular. Therefore, for example, in the case that all pixels on one surface are isolated points, the number of edges becomes four times of the number of pixels.

Further, the edges in the main scanning direction and those in the sub-scanning direction are separately counted.

Next, the integrating unit 25 integrates the number of pixels, the number of edges and the pattern matching number and stores them, respectively. Then, the consumption estimation unit 26 reads the characteristic information of the image (referred to as image characteristic information; it contains the number of pixels, the number of edges and the pattern matching number in this embodiment), which is stored in the integrating unit 25 and has been printed by then, with a predetermined timing during printing.

Herein, the numbers matched with the number of pixels, the number of edges and the number matched with predetermined patterns are integrated according to the entered/processed image data; however, the integrated values are cleared at the time of starting printing of one page, and they shall be integrated during the printing on one page. In addition, the integrating unit 25 can read during printing, as well, and each integrated value by then with regard to the entered/processed image data at the time of reading can be acquired, respectively. In this embodiment, it is designed such that the consumption estimation unit 26 reads out the integrated values counted by the integrating unit 25 when printing of one-half of page is completed, and in addition, reads out the integrated values of the integrating unit 25 again at the time of completion of printing said one page (the integrated value read at the time of printing one-half of page is referred to as ‘one-half page integrated value’, and the integrated value read at the time of completing the printing of said page is referred to as ‘entire page integrated value’), by the toner supply controlling unit 29.

Further, the timing for reading the one-half integrated value is determined by counting a time equivalent to that from the start of printing to the completion of processing of one-half page of image data.

Next, because of the toner supply controlling unit 29, the consumption estimation unit 26 estimates a toner amount, which has been consumed by the printing for one-half of page (referred to as consumed toner amount), based upon the one-half page integrated value read by the integrating unit 25. Specifically, the consumed toner amount is an addition by integrating each integrated value in the image characteristic information by a predetermined coefficient, respectively. Herein, this predetermined coefficient is an experimentally-acquired in advance. Further, even this consumption estimation unit 26 is designed to calculate the consumption per one-half page, and it calculates two types, which are the one-half estimated consumption calculated based upon the one-half page integrated value and the entire page estimated consumption calculated based upon the entire page integrated value are calculated.

Next, the supply operating unit 28 calculates a drive time of the toner supply motor 27 required for supplementing the estimated amount of toner (consumed amount of toner).

Herein, the toner contained within the toner reservoir 30 is conveyed by rotating the conveyance screw 31 driven by the toner supply motor 27, and falls into the inside of the development device 10. Then, the toner supply motor 27 uses a stepping motor, and if the maximum pulse rate is fixed, the toner amount, which is conveyed by a total pulse and supplied to the development device 10, is uniquely defined. Therefore, the supply operating unit 28 calculates the number of total pulses of the toner supply motor from the toner amount to be supplied, and transmits the value to the motor drive circuit 33. Furthermore, even in the case of so-called slow-up and slow-down operations that change a pulse rate in stage at the time of start and stop of driving the toner supply motor 27, if the change inclination is constant, the total pulse number and the supply toner amount can be correlated.

Further, the motor drive circuit 33 drives the toner supply motor 27 only during the time period corresponding to the entered total pulse number. Then, the toner supply motor 27 rotates the conveyance screw 31 via the gear sequence 32, and supplies a predetermined amount of toner to the development device 10.

Further, the calculation shall be conducted per one-half page even herein, and a pulse number necessary for the one-half page estimated consumption and the entire page estimated consumption is calculated, respectively.

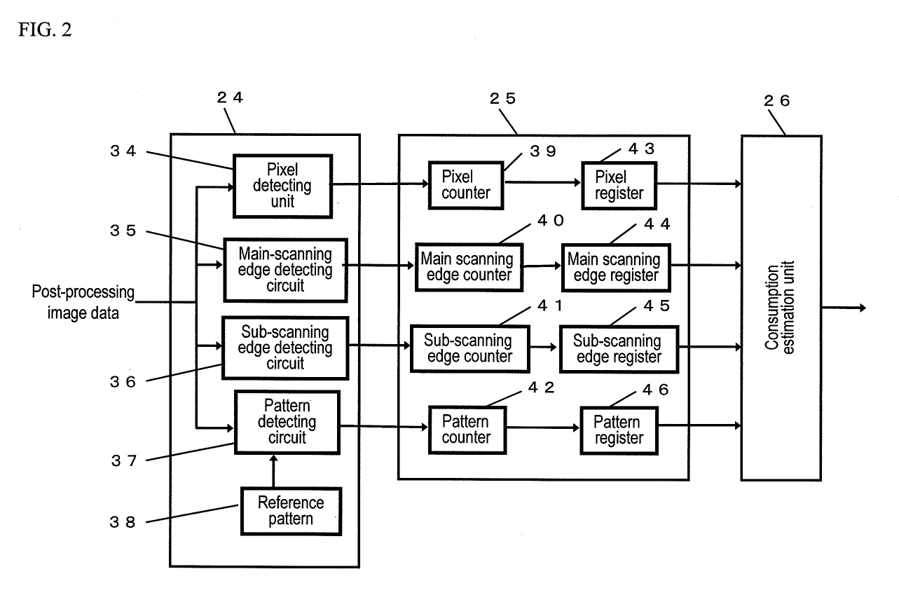

FIG. 2 shows a block diagram of a part of the toner concentration controlling unit 1.

In FIG. 2, the image characteristic detecting unit 24 is composed of a pixel detecting circuit 34 for detecting the number of printed pixels of an image, a main scanning edge detecting unit 35 for detecting whether or not the pixel is an edge of the main scanning direction, a sub-scanning edge detecting circuit 36 for similarly detecting whether or not the pixel is an edge of the sub-scanning direction, and a pattern detecting circuit 37 for detecting that multiple pixels composed of one certain pixel and its peripheral pixels centered on the pixel match a pre-set reference pattern 28.

Further, the integrating unit 25 is composed of a pixel counter 39 for counting the detected number by the pixel detecting circuit 34, a pixel register 43 for temporarily storing the number in the pixel counter 39, a main scanning edge counter 40 for counting the detected number in the main scanning edge detecting circuit 35, a main scanning edge register 44 for temporarily storing the value in the main scanning edge counter 40, a sub-scanning edge counter 41 for counting the detected number by the sub-scanning edge detecting circuit 36, a sub-scanning edge register 45 for temporarily storing the value in the sub-scanning edge counter 41, a pattern counter 42 for counting the detected number by the pattern detecting circuit 37 and a pattern register 46 for temporarily storing the value in the pattern counter 42.

For the toner concentration controlling unit 1 with the above-mentioned configuration, its operation is as follows:

The image data processed by the image signal processing circuit 2 shown in FIG. 1 is entered into the pixel detecting circuit 34, the main scanning edge detecting circuit 35, the sub-scanning edge detecting circuit 36 and the pattern detecting circuit 37 in the image characteristic detecting unit 24 in parallel.

Herein, the image data entered into the main scanning edge detecting circuit 35, the sub-scanning edge detecting circuit 36 and the pattern detecting circuit 37 is image data of multiple pixels composed of one certain pixel and peripheral pixels centered on said certain pixel.

In other words, the data entered into the main scanning edge detecting circuit 35 is image data of said center pixel and its right and left pixels, and the data entered into the sub-scanning edge detecting circuit 36 is image data of said center pixel and its up-and-down pixels. Further, the data entered into the pattern detecting circuit 37 is image data of pixels whose size is 3×3 centered on said center pixel. This size is determined according to the size of the pre-set reference pattern 38.

Subsequently, in the image character detecting unit 24 where the image data is entered, the detection signals transmitted from the pixel detecting circuit 34, the main scanning edge detecting circuit 35, the sub-scanning edge detecting circuit 36 and the pattern detecting circuit 37 become high level (a high potential in the digital electric signal) when they match each condition, respectively.

In other words, the pixel detecting circuit 34 transmits a high level of detection signal when said center pixel is a pixel to be printed (a pixel where an image is formed (a toner is attached)), and it remains at a low level (a low potential in the digital electric signal) in other cases.

Further, the main scanning edge detecting circuit 35 detects whether or not said center pixel is an edge in the main scanning direction. In other words, when said center pixel is a pixel to be printed and either the right or left pixel is non-printed pixel (pixels where no image is formed (a toner is not attached), a high level of detection signal is transmitted. At this time, since it could happen that the right and left pixels are both non-printed pixels, two bits are required for the detection signals.

Further, similarly, the sub-scanning edge detecting circuit 36 transmits a high level of detection circuit when said center pixel is a pixel to be printed and either up or down pixel is non-printed pixel. At this time, it could happen that the up and down pixels are both non-printed pixels, two bits are required for the detection signals, as well.

Further, the pattern detecting circuit 37 transmits a detection signal when the arrangement of the printed pixels of said center pixel and its peripheral pixels matches the pre-set reference pattern 38.

Furthermore, an amount of the information (necessary bit number) of detection signal is determined according to the number of the reference patterns.

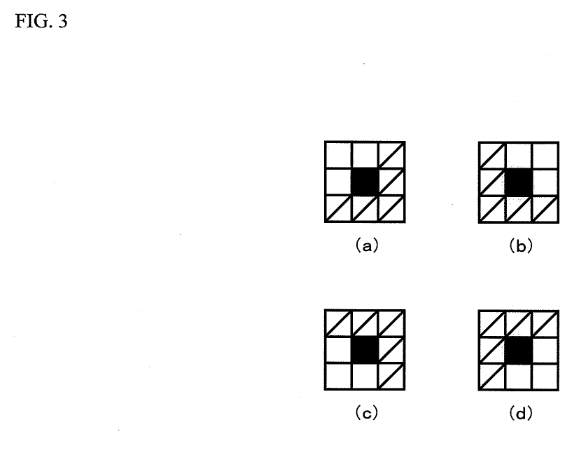

FIG. 3 shows the reference patterns 38 used in this embodiment. Herein, in this embodiment, 3×3 pixels shall be referred at maximum on the center of said center pixels, and the black portion and the white portion in FIG. 3 represent a pixel to be printed and a non-printed pixel, respectively, and an oblique line can represent either one.

As it is clear from FIG. 3 (a) through FIG. 3 (d), whether or not said center pixel is a local angle is detected. Since the reference patterns 38 have four types, it is necessary to transmit signals of 0 to 4, thus three bits are required for detection signals at minimum. Furthermore, when the reference patterns are defined and it is unnecessary to change them, they may be composed with a combined logic circuit from a picture signal with 3×3 pixels, 9 pixels, at maximum.

Referring back to FIG. 2 again, each detection signal generated by the image characteristic detecting unit 24 is entered into a corresponding counter in the integrating unit 25. Herein, in the integrating unit 25, the values of counters in the pixel counter 39, the main scanning edge counter 40, the sub-scanning edge counter 41 and the pattern counter 42 are cleared immediately before the start of printing, respectively, and then, the image data is entered into the image signal processing circuit 2 and a corresponding detection signal is integrated in each counter during the printing of image on one page. Then, the pixel register 43, the main scanning edge register 44, the sub-scanning edge register 45 and the pattern register 46 in the latter parts latch each corresponding counter value and these are stored at the time of completion of printing of one page, respectively.

Then, each value of the pixel register 43, the main scanning edge register 44, the sub-scanning edge register 45 and the pattern register 46 is entered into the consumption estimation unit 26 in the latter part, and the consumption estimation unit 26 estimates the toner amount, which seems to be consumed during this printing.

Herein, the estimation processing itself is defined as a function of each register value, and specifically, each register value is multiplied by a predetermined coefficient and summation is added. In other words, a value stored in the pixel register 43 is calculated as Cₚᵢₓ, the value stored in the main scanning edge register 44 is calculated as Cₑₘ, the value stored in the sub-scanning edge register 45 is Cₑₛ, and the value stored in the pattern register 46 is calculated as Cₚₐₜ, and the toner consumption T_{con} is calculated using the following expression:

T_{con}=K1×Cₚᵢₓ+K2×Cₑₘ+K3×Cₑₛ+K4×Cₚₐₜ

Herein, K1, K2, K3 and K4, which are coefficients, are pre-defined according to experiments.

Since the toner consumption by printing can be estimated with the above-mentioned operation, this device supplements the consumed toner. At this time, the supply operating unit 28 calculates the necessary motor drive time from the toner amount to be supplemented. Further, the motor drive circuit 33 generates a motor drive signal based upon the drive time calculated by the supply operating unit 28.

The operation of the toner concentration controlling unit 1 is as described above.

Subsequently, the toner supply operation in this device will be described using time charts.

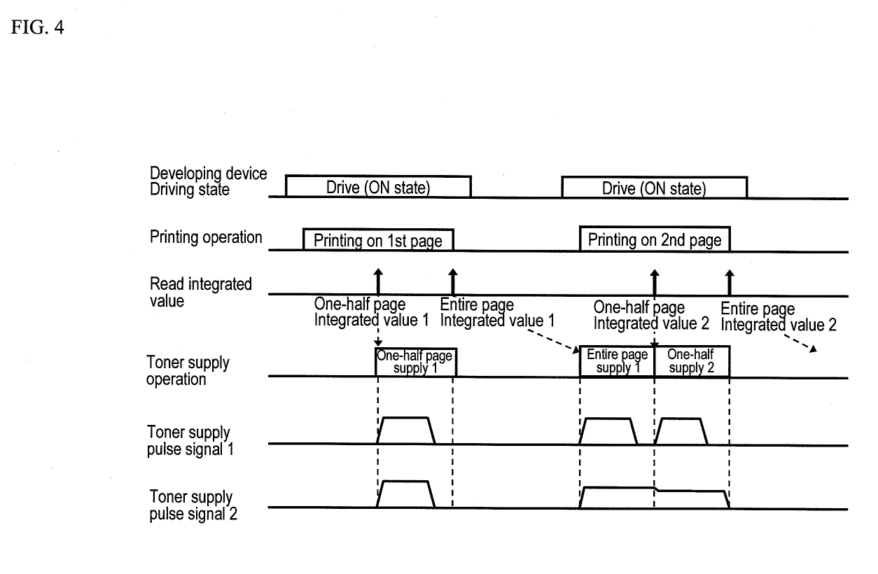

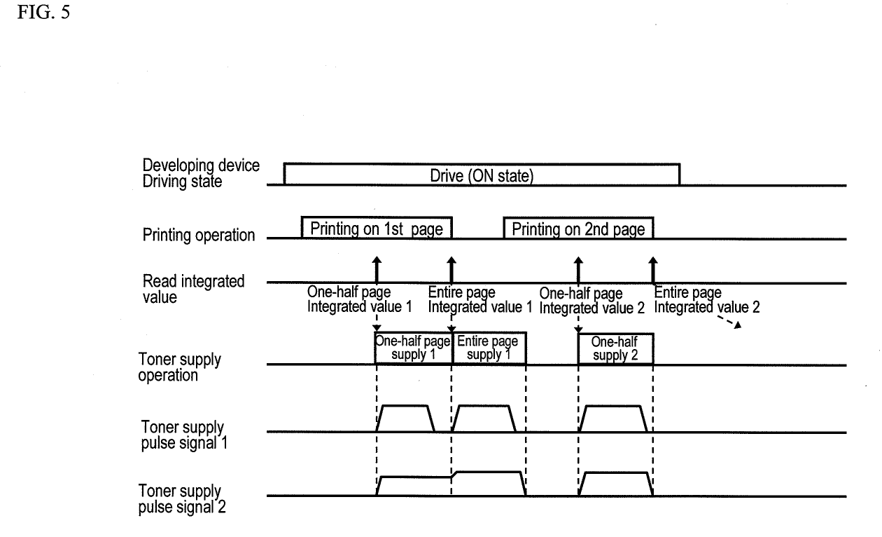

FIG. 4 and FIG. 5 show time charts at the time of printing operations. Herein, FIG. 4 shows a time chart of intermittently printing images of two pages, i.e., at the time of so-called intermittent printing operation, and FIG. 5 shows a time chart of continuously printing images of two pages, at the time of continuous printing operation.

In FIG. 4, this device acquires a one-half page integrated value (one-half page integrated value 1) in the middle of printing of the first page, and calculates the half-page estimated consumption and a pulse number required for the toner supplement for the consumption, and starts the one-half supply operation (one-half page supply 1). After that, it acquires an entire page integrated value at the time of completion of printing one page, and calculates the entire page estimated consumption and the supply pulse number. However, because the drive of the development device is stopped immediately after the completion of printing, the toner supply operation will not be conducted. At this time, the consumption to be calculated is an amount a consumption to be calculated based upon the already-supplemented one-half page integrated value is subtracted from the consumption to be calculated based upon the entire page integrated value. The toner amount calculated herein is supplied at the time of next printing operation. This is because if a toner is supplied under condition where the development is not driven, concentration unevenness occurs to the toner concentration within the development device because of no agitation; therefore, it is designed to supply a toner always when the development device is in a driven state.

Then, when a time has passed and printing of the second page is started, first, this device supplements a toner for a consumed portion during the previous printing operation. The one-half page integrated value is acquired when the printing of the one-half page is completed, and the one-half page estimated consumption is calculated and the one-page supply movement (one-half page integrated value 2) starts. After that, the toner supply based upon the entire page integrated value on the second page to be acquired at the time of completion of the printing on the second page will be carried forward to the next printing movement.

As described above, this device divides one page into the first half and the second half, and an amount of the toner, which is estimated as a consumed amount in the first half, is supplemented during the second half printing operation, and another amount of the toner, which is estimated as a consumed amount in the second half, is supplemented during the first half of the next printing operation. The drive pulse signal of the toner supply motor (a state pattern during the period a pulse is transmitted) at this time is shown as the toner supply pulse signal 1. With this design, since the timing between the toner consumption and the supplement for the consumption can be shortened from the conventional delay, which is for one page, to a one-half page of delay, a fluctuation in the toner concentration within the development device 10 can be moderated substantially to one-half.

Herein, the reason why the toner supply operation is ended at the same timing as the completion of the printing movement is because the supplied toner can be sufficiently agitated within the development device 10. In other words, normally, even if the printing operation is ended, the development device 10 is designed to be continuously driven for several seconds, thus the ending timing of the toner supply operation is set as described above so as to sufficiently agitate the already-supplied toner by the agitating screw within the development device 10. As described above, the toner supply movement is ended or interrupted before the predetermined time for stopping the agitating screw.

Next, even in the continuous printing operation whose time chart is shown in FIG. 5, the basic operation is the same as that in the case of the intermittent printing operation. However, in the continuous printing operation, because the development device 10 will never stop between the first page and the second page, this device starts supplementing a toner with an amount, which is estimated as the consumed amount in the second half of the first page, when the entire page integrated value after the completion of printing on the first page is acquired and the entire page estimated consumption is calculated. The timing to start may be switched according to whether or not the continuous printing operation is conducted. Furthermore, the point where the toner supplement, which is estimated as a consumed amount in the second half of the final page, is carried forward to the next printing operation is the same.

Furthermore, herein, a stepping motor is used for the toner supply motor 27, and the toner amount to be supplied is controlled by the driving pulse number for driving at a constant pulse rate. However, the present invention is not limited to this, but for example, it is also possible to change the maximum pulse rate and to control the toner amount to be supplied in order to lengthen the toner supply time as much as possible for the purpose of preventing the unevenness of the toner concentration within the development device 10. The drive pulse signal (a state pattern during the period when a pulse is transmitted) of the toner supply motor is shown as the toner supply pulse signal 2 in FIG. 4 and FIG. 5, respectively. In this case, if the toner supply time is set at constant and the maximum pulse rate is changed, a supply amount per unit time, and a total supply amount by extension, shall be controlled; however, since the supply per unit time can be comparatively smaller, the toner concentration unevenness within the development device 10 can be prevented.

Further, in this embodiment, in order to obtain the reading timing of the integrated value, it is designed such that an elapsed time from the start of printing is counted and acquired; however, the present invention is not limited to this. It may be designed to acquire the integrated value when a predetermined line number, for example, one-half of the total line number in one page is counted, using a line counter incorporated into the hardware so as to enable the counting a raster (line) number on an image. In addition, in the present embodiment, it is designed such that one page is divided into two and an integrated value is acquired; however, it may be divided into three or more. Further, on the occasion of division, they do not have to be equally divided. In addition, the number of divisions may be differentiated according to an environmental factor or a toner characteristic.

Further, the consumption estimation unit 26 may time-sequentially read the integrated value from the integrating unit 25 from the start of printing, and sequentially calculate the consumed toner amount with regard to the read integrated value. When the consumed toner amount exceeds a pre-defined threshold value, the supply operating unit 28 transmits the drive time corresponding to the threshold value to the motor drive circuit 33, and generates a motor drive signal. If the consumed toner amount exceeds a threshold value and the motor drive signal is generated, the integrated value is cleared once, and new integration will be started. The integration will be continued until printing on one page is completed. If the consumed toner amount of toner is completely supplemented by the time when the printing on one page is completed, the consumed toner amount is estimated based upon the integrated value at the time when the printing on one page is completed, and the consumed toner amount is carried forward to the next printing; therefore, the estimated consumed toner amount is set as an initial value of the consumed toner amount at the time of start of next printing. In the case that the toner of the consumed toner amount is not completely supplemented by the time when the printing on one page is completed, an added amount of the remaining amount and the consumed toner amount based upon the integrated value at the time of completion of the printing on one page will be set as an initial value of the consumed toner count at the time of start of next printing.

Further, for example, if toner consumption is very small amount, the toner supplement may be limited. When the toner consumption is a very small amount, it is possible that the toner may be excessively provided due to the supplement operation. In order to avoid this, when the estimated consumption exceeds the predetermined threshold value, the developer can be supplied. If it does not exceed the threshold value, the developer will not be supplied.

Further, in this embodiment, it is designed to estimate the consumption acquired as the integrated value and to supplement the amount. However, the consumption estimated based upon the one-half page integrated value is predicted to double and the amount may be supplemented at the time of printing on the second half of the page. At that time, if the integration with the already-supplemented amount is conducted at the time of acquiring the entire page integrated value and calculating the entire page estimated value, an error due to the estimation can be eliminated.

As described above, the toner supply movement was described using the time charts per printing operation.

Next, the toner supply operation of this device will be described using a flowchart.

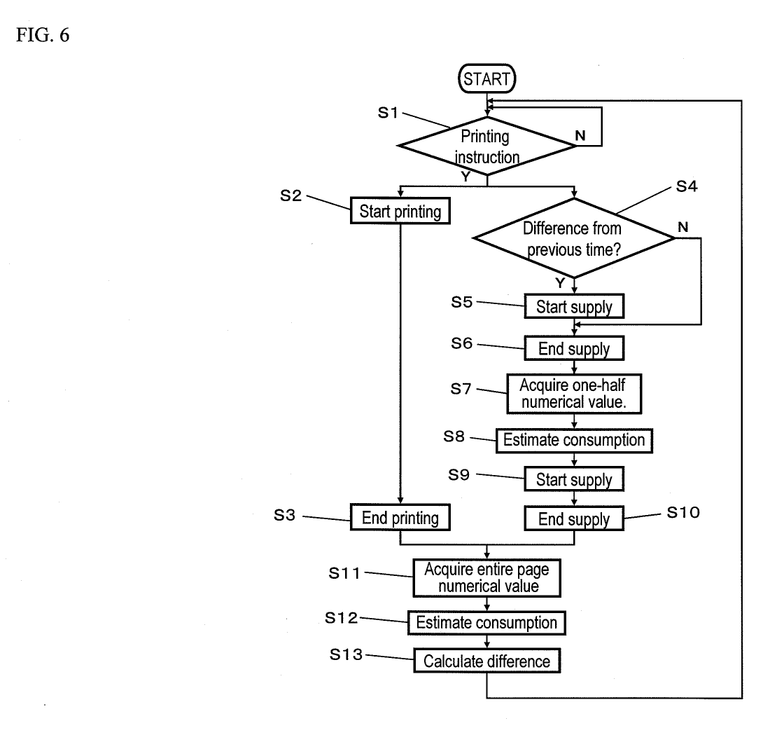

FIG. 6 shows a flowchart of this toner supply operation.

In FIG. 6, when this device starts its processing, for the printing operation, it stands by until a printing instruction (S1) is received from CPU. Then, when the printing instruction is received, the printing operation is started in not-shown sheet feeder controlling unit and image formation process controlling unit (S2). After that, when the printing operation on one page is completed, the printing completion processing is conducted (S3). In the meantime, in parallel to the image formation process, the toner concentration controlling unit performs the toner concentration controlling operation within the development device 10.

When the toner concentration controlling unit, first, starts the printing operation and drives the development device 10, it determines whether or not the toner supplement has any deficiency due to the previous printing movement (S4), and if a toner needs to be supplemented, the supply will be started (S5). This supply operation is set so as to complete in roughly one-half of the time period compared to the actual printing operation (S6). If there is no toner amount to be supplemented, the toner supplement is regarded as none at this time, and it is designed such that the no toner supply movement is conducted.

After that, a value of each counter is read at the time when one-half of the printing operation is completed; in other words, at the time when one-half of the image data flows and the number of pixels on the one-half page and other counter are counted (S7). These values shall be the one-half page counted values, respectively. A toner consumption for one-half page is estimated based upon these one-half page values (S8). The estimated value herein will be the toner estimated consumption for one-half page. When the toner estimated consumption for one-half page is calculated, the amount of toner supply is promptly started (S9). Herein, as similar to S5 to S6, a toner is supplied in the printing operation time for approximately one-half page, and the toner supply is completed when the printing operation is completed (S10).

After that, since counting of the page is all completed at the time of completion of printing for one page, values of all counters are read herein (S11). Each counter value read herein is an entire page counting value, which is a counting value for one page, respectively. As similar to S8, the toner consumption for the entire pages is estimated based upon these entire page counting values (S12). The toner consumption estimated based upon the half-page counting value in S8 is subtracted from this toner consumption for the entire pages, and a toner amount, which is estimated as a consumed amount in the second half of the page, in other words, an amount that has not been supplemented, is calculated from the amount, which is estimated as consumed in one page (S13). The toner for this difference amount will be supplied in the first half of the next printing movement.

The above-mentioned operation is a toner supply controlling operation in the printing movement for one page. When there is another image to be continuously printed, the above-mentioned processing shall be repeated.

Since the value calculated as a toner supply is absolutely an estimated value, an error occurrence cannot be avoided. Then, even if the error in one supply is small, it is possible that the accumulation of the errors may be increasing to an unignorable error. Therefore, a means for canceling this accumulated error becomes required. Hereafter, the concentration correction processing for cancelling the accumulated error in this embodiment will be described.

First, in order to conduct the concentration correction processing, it becomes necessary to detect the toner concentration within the development device 10 with some method. Conventionally, a magnetic permeability sensor was arranged within the development device 10 and the toner concentration was detected by utilizing the phenomenon that when a mixture ratio of a toner to a carrier was changed, a magnetic permeability of the developer was also changed. However, because this magnetic permeability sensor is a comparatively expensive component and an image is formed with four development devices, which are cyan, magenta, yellow and black; in the case of a color image forming device, four magnetic permeability sensors are also required, and this causes a cost increase. Then, when the developer concentration within the development device not directly but when a printing operation with a predetermined number is conducted, a method to indirectly detect the toner concentration within the development device by detecting the density of the toner image developer with predetermined patterns may be adopted. In this case, patterns for density detection are formed on the photoreceptor drum 7, and an the detection is conducted using inexpensive density sensor composed of a light-emitting element and a light-receiving element arranged in the vicinity of the photoreceptor drum. Then, in this case, in addition, in order to reduce the cost, a toner image on an intermediate transcriptional body is detected instead of detecting a toner image on the photoreceptor drum. This is because the density sensor can be shared in the detection of the toner image on the intermediate transcriptional body; in the meantime, in a color image forming device, if the density is attempted to be detected on the photoreceptor drum, four density sensors are required. In this embodiment, the density is detected on the intermediate transferring belt.

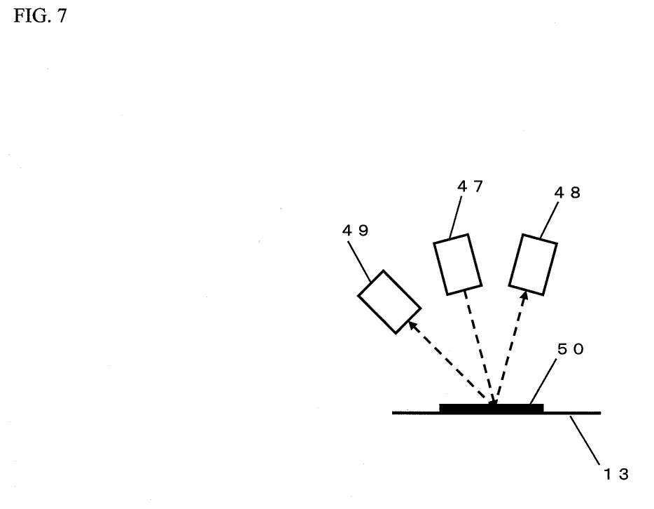

FIG. 7 shows a configuration diagram of the density sensor. The density sensor shown in FIG. 7 is composed of a light-emitting element 47 that emits an infrared ray and light-receiving elements 48 and 49 that receive the infrared ray. Herein, the light-emitting element 47 is mounted at the position to irradiate an infrared ray to the intermediate transferring belt 13 with a predetermined angle of incidence, and the light-receiving element 48 for directing receiving a reflected light is positioned at an opposing position having an angle of reflection, which is the same as the angle of incidence. In the meantime, the light-receiving element 49 that receives a scattering light is arranged at a position where the reflected light will not directly enter.

In this configuration, the operation of the density sensor will be described next.

When the intermediate transferring belt 13 is turned and is situated at the position where a density patch 50 is formed over the belt, the light-emitting element 47 irradiates an infrared ray with a predetermined angle of incidence. The irradiated light is reflected by the density patch 50, i.e., by a toner image formed with predetermined patterns. Among the reflecting lights, a directly-reflected light enters into the light-receiving element 48 with the same angle of reflection as the angle of incidence. In the meantime, a portion of light diffusely reflected on the surface of the toner image enters into the light-receiving element 49 as a scattering light. Which element is used for detection, either the light-receiving element 48 or 49, shall depend upon the color to be detected. In other words, the density of three colors, cyan, magenta and yellow, is detected using a scattering light. This is because if the toner concentration on the intermediate transferring belt 13 becomes higher, since the toner attachment becomes greater for the increase in the toner concentration, a quantity of light in the scattering light component becomes greater, and the out of the light-receiving element 49 also becomes higher. In the meantime, for black, a direct reflected light is utilized. Because a black toner absorbs lights, the light in the scattering light component can hardly be detected. Herein, in general, the intermediate transferring belt is black and its surface has a comparatively higher reflectivity. Consequently, when a toner is not mounted, a quantity of the direct reflected light is great, and if the toner attachment is increasing, the scattering light component is increased and the direct reflect light component is decreased; therefore, the concentration of the black toner can be detected in the level of the light-receiving element 48.

Next, procedures of concentration correction processing using this density sensor will be described.

As the procedures for the processing, when a predetermined number of printing operation is conducted, first, the density patch 50 is formed on the intermediate transferring belt 13, and then, when the intermediate transferring belt 13 turns and the density patch 50 is situated at the position of the concentration sensor 23, the concentration is detected as described above.

Herein, a difference between the detected concentration and the concentration detected in the condition where a standard density of developer is pre-contained is equivalent to an accumulated error.

Therefore, the excess or deficiency of the toner amount is calculated from the detected concentration, and if the toner is insufficient, the toner is forcibly supplemented. On the contrary, when the toner is excess, it is designed not to supply the excess toner amount from the next printing until the toner is consumed.

Herein, if the concentration correction with these procedures is conducted, the accumulation of the consumption estimation error per printing is canceled, and the toner amount within the development device can be corrected to a predetermined standard amount; in the meantime, because this concentration correction processing is conducted regardless of a user's intention in general, there are also disadvantages, for example, a toner is excessively consumed, or the printing becomes halted waiting during the continuous printing in some cases.

Then, since it is desirable not to conduct this correction processing as much as possible or to reduce the frequency, it is designed in this device such that the correction processing is not conducted when a predetermined number of printing operations is completed, but estimate values of the toner consumption after the concentration correction processing are integrated, and when a total of the consumption estimated value exceeds a predetermined amount, the correction processing is conducted.

For example, an aggregate value value from the previous correction of the consumption estimated value is obtained when printing of one-half of page is completed, and the aggregate value is further obtained even when printing of one page is completed. Then, the obtained aggregated value is compared to a predetermined threshold value, and when the obtained aggregated value exceeds the threshold value, the concentration correction processing is executed.

With this design, when an image with a lower printing ratio having a comparatively low error is printed, intervals of the concentration correction processing can be extended, and in addition, when a toner is greatly consumed and errors are accumulated, the intervals of the concentration correction processing can be shortened, and the toner concentration within the development device can be stably controlled in various cases.

Furthermore, it may be designed such that a timing to acquire an integrated value by the consumption estimating unit 26 from the integrating unit 25 is adjusted by the accumulated error.

As described above, the concentration correction processing was described.

The operations described up to now are for normal printing operations. However, in actuality, even if it is very rare but the device could stops in the middle of the printing operating due to an abnormality such as abnormal conveyance of recording sheet, which is so-called paper jam. In that case, in the photoreceptor drum 7, a region that has been exposed but not developed yet (a toner has not been transferred yet) may exist.

In other words, since a data signal, which is referred to as a laser drive signal in the laser drive circuit 3, and which is the same as that in the image data, flows into the image characteristic detecting unit 24, which is an input source of the integrating unit 25 and detects the number of pixels, the number of pixels is detected when a laser beam is emitted to the exposure position on the peripheral surface of the photoreceptor drum 7 for said pixels. In the meantime, since the development is conducted at the development position where the photoreceptor drum 7 and the development sleeve 20 of the development device 10 are facing against each other, when the exposed portion achieves its development position for the pixels relating to the peripheral surface of autorotating photoreceptor drum 7, the toner within the development device 10 is attached to the exposed portion and the toner is consumed for the first time.

As described above, the region between the exposure position and the development position on the peripheral surface of the photoreceptor drum 7 is a region that has been exposed but not developed yet, i.e., an exposed & not-developed region where the number of pixels is detected but no toner has been consumed, and the number of pixels outputted by the image characteristic detecting unit 24 includes the number of pixels to be printed for this exposed & not-developed region. Therefore, when the device stops in the middle of the printing operation due to an abnormal, such as paper jam, the number of pixels to be printed for this exposed & not-developed region is detected but no toner is consumed; therefore, the toner for that portion shall be supplied extract in the toner supply operation thereafter.

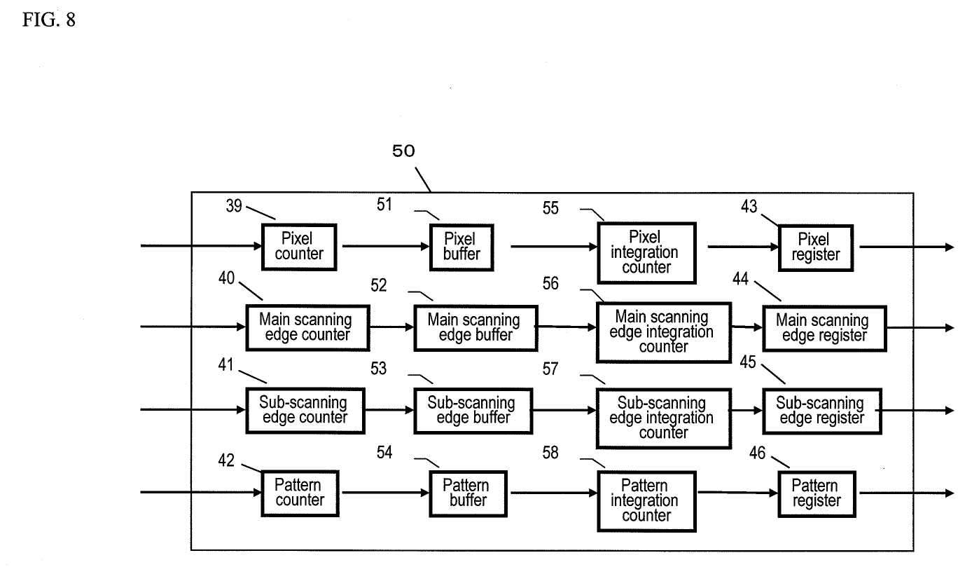

In order to prevent the excess supply of toner, the configuration shown in FIG. 8 (when this configuration is particularly distinguished from the integrating unit 25 shown in FIG. 2, it is referred to as the second integrating unit 50, as well) instead of the configuration of the integrating unit 25. In other words, the second integrating unit 50 is a relative type of the integrating unit 25, and this is for eliminating the excess supply of toner relating to the exposed & non-developed region.

FIG. 8 is a block diagram showing the configuration of the second integrating unit 50.

In FIG. 8, buffers (51 to 54) and integrating counter (55 to 58) are established between counters (39 to 42) and registers (43 to 46), which are similar to those in the integrating unit 25. Then, every time each counter (39 to 42) counts for one line (integration; referred to as counting within the scope of this explanation for the purpose of distinguishing from the integration by the integrating counter), the counter value is stored in the buffer (51 to 54), and the counter is reset.

In this configuration, each counter (39 to 42) stores the counted value per line in the buffer (51 to 54), and then, synchronizing the counted line situated at the development position, the toner concentration controlling unit 1 integrates each integrating counter (55 to 58). Herein, it is preferable that the time of integration and the time when the line is situated at the development position are simultaneous; however, they can be close, which can be considered as substantially simultaneous. Then, the time of the integration can be obtained by a delay means, such as a timer, providing a delay for the time period when the related exposed portion achieves the development position (equivalent to the time period for movement of a predetermined distance on the outer circumferential surface of the autorotating photoreceptor drum 7) from the point when a laser beam is emitted to the exposure position of the photoreceptor drum 7.

With these buffers (51 to 54) and integrating counters (55 to 58), since the integration of the number of pixels can be conducted by delaying the timing not at the time when a laser beam is emitted to the exposure position but at the time when the exposed portion achieves the development position, it can be considered that the exposed & not-developed region is substantially eliminated. Therefore, even when the device stops in the middle of the printing operating due to the abnormality, such as paper jam, since the integrated number of pixels is for pixels where a toner has been consumed, the toner will never be supplied extra as described above in the toner supply operation thereafter.

Due to the configuration and operation as described above, in an image forming device, when the printing operation is completed, since the balance between the consumption and supplement of toner is merely deficiency for one-half of page, the fluctuation in the toner concentration within the development device 10 can be controlled to roughly one-half compared to the conventional one, and in addition to the concentration correction processing, an image with stable concentration can be obtained in various cases.

Furthermore, in this embodiment, because of the simplification, a monochromatic image forming device was described; however, the present invention can be realized even in a multicolor image forming device by comprising this toner concentration controlling device independently in each color.

Further, in this embodiment, the integrating unit 25 is designed to count and integrate the numbers of pixels to be printed and edges detected by the image characteristic detecting unit 24; however, when the pixel has concentration information relating to printing as data (when the pixels data is so-called multivalued), the concentration information (multivalued data) in the numbers of pixels to be printed and edges detected by the image character detecting unit 24 are counted and integrated by each counter.

### Embodiment 2

Next, Embodiment 2 of the present invention will be described.

In this embodiment, the image forming device (referred to as this device) 1 has the configuration of the image forming device, and the toner concentration controlling unit 1 further comprises a toner consumption database to images printed by this device.

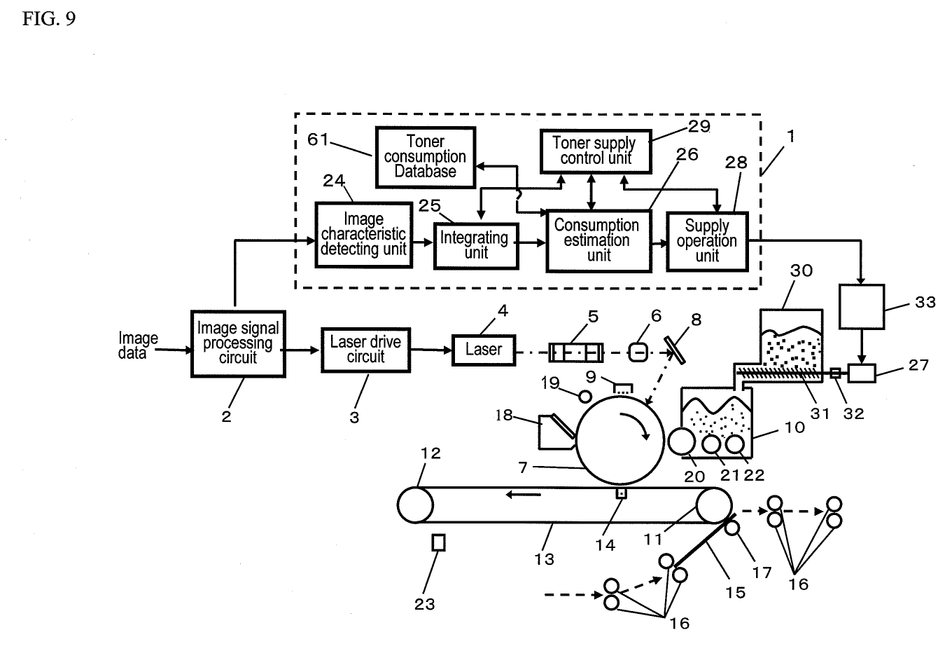

FIG. 9 shows a skeleton framework of the image forming device in this embodiment.

In FIG. 9, a toner consumption database 61 stores the history of toner consumption per page, and this device sequentially calculates an average value of the toner consumption (referred to as average toner consumption) from the beginning and an average value of the toner consumption of latest five pages (referred to as latest toner consumption) every time the printing operation is conducted.

The electrographic image forming process is the same as that in Embodiment 1.

Hereafter, the operation of the image forming device with this configuration will be described.

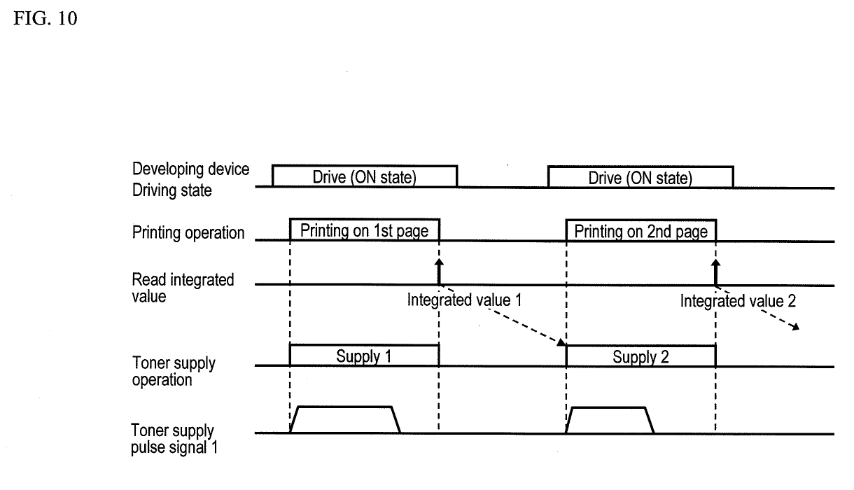

FIG. 10 shows a time chart in this embodiment.

An average toner consumption for printing of 5% manuscript (a manuscript of image whose manuscript ratio is 5%) in a standard environment, i.e. NN environment (temperature: 23 degrees C., humidity: 50%) is stored in the toner consumption database 61 as each initial value.

In FIG. 10, this device supplies the average toner consumption stored in the toner consumption database 61 at the time of printing the first page as a supply 1. Then, since an integrated value 1 on the first page can be acquired when printing on the first page is completed, an estimated consumption is calculated based upon the integrated value 1. After that, the calculated value of estimated consumption is sent to the toner consumption database 61.

Then, the value of the estimated consumption sent to the toner consumption database 61 is used for updating the average toner consumption.

Specifically, when the update value of the average toner consumption is Tₐᵥₑ, the average toner consumption up to now T_{old}, the printed number up to the present is P_{count} and the estimated consumption at this time is T_{now}, the average consumption is calculated with the following expression:

Tₐᵥₑ=((T_{old}×(P_{count}−1)+t_{now})/P_{count}

Further, the amount of the estimated consumption is simultaneously used for the calculation of the latest toner consumption T_{rct} for the last 5 pages at the same time. Herein, the latest toner consumption T_{rct} is an average value of the toner consumption of recent five pages, and every time this device prints, a subject for average is updated, and a value of the estimated consumption for 6 pages and prior at that time shall be disposed.

Furthermore, in this device, the recent toner consumption is not used, but the average toner consumption is used and a toner is supplied ahead of schedule.

After that, in this device, for a difference between the estimated consumption calculated on the first page and the average toner consumption before the updated supplied at the printing operation on the first page, the excess or deficiency is adjusted at the next printing.

Then, the supply 2 to be supplied at the time of printing the second page is calculated as follows:

(T_{now}−T_{old})+Tₐᵥₑ

As described above, this deice updates values in the toner consumption database 61 every time the printing operating is conducted, and the supply at the next printing operation is calculated in advance using the updated value.

Next, a toner supply operation per printing operation will be described using a flowchart.

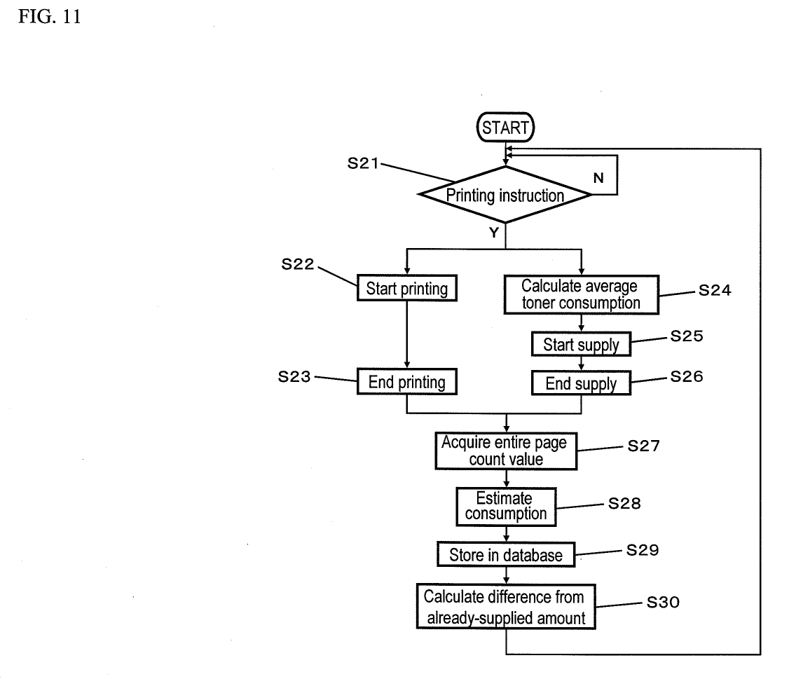

FIG. 11 shows a flowchart of toner supply operation in this embodiment.

In FIG. 11, when this device starts its processing, regarding the printing operation, first, it stands by until a printing instruction is received from CPU. Then, once the printing instruction is received, a printing operation is started at not-shown sheet feeder controlling unit and image formation process controlling unit (S23). After that, when the printing operation on one page is completed, the printing completion processing is conducted (S23). In the meantime, in parallel to the image formation process, the toner concentration controlling unit performs the toner concentration control operation within the development device 10.

In the toner concentration controlling unit, at first, the printing operation is started and the development device 10 is driven, an average toner consumption is calculated by referring to the toner consumption database where the history of estimated toner consumption in the past is stored (S24). After that, only the calculated amount is supplied (S25). This supply operation is completed until the actual printing operation is completed (S26).

Then, since counting of the pages is all completed when the printing on one page is completed, values in all counters are read out herein (S27). The counter values read out herein are counted values for all pages, which is a counted value for one page, respectively. The toner consumption for all pages is estimated based upon the counted values for all pages (S28). The toner consumption estimated herein is stored in the toner consumption database (S29), and the average toner consumption is re-calculated within the database. Then, a difference between the toner estimated consumption estimated herein and the already-supplemented average toner consumption is calculated (S30). At this time, if the average toner consumption is greater, it means that a toner has been excessively supplemented; therefore, this difference is subtracted from the average toner consumption, the obtained amount is supplemented at the next printing operation. On the contrary, if the toner estimated consumption is greater, it means that the supplement is insufficient; therefore, this difference is added to the average toner consumption, and the obtained amount is supplemented at the next printing operation.

The above-mentioned process is the toner supply controlling operation in the printing operation for one page. If there is another image to be printed continuously, the above-mentioned processing shall be repeated.

Furthermore, in this embodiment, an amount to be supplemented is calculated using the average toner consumption. However, the amount to be supplemented may be calculated using the value of the recent toner consumption stored in the toner consumption database 61 instead. In addition, these may be combined with a predetermined ratio. The average toner consumption is reflected by all of printing histories in the past, and on the occasion of printing a defined image, the accuracy becomes excellent. In the meantime, in a use of printing various images one after another, the improvement of accuracy can be expected using the recent toner consumption. In addition, in the case of combining the both with a predetermined ratio, for the ratio, a fixed distribution factor is set in advance or a user can freely set. In addition, the ratio may be designed to be automatically changed from the degree of fluctuation in the estimated consumption calculated from an acquired integrated value. According to this design, for example, if the fluctuation in the estimated consumption per page is small, it is considered that the printing subject is a finite document in many cases, and if the ratio of the average toner consumption is automatically increased, the estimated accuracy can be improved.

Further, in this embodiment, it is designed such that the values of the average tone consumption and the recent toner consumption stored in the toner consumption database 61 are sequentially updated every time the printing operation is conducted; however, in order to simplify the processing, an average toner consumption is determined in advance and this value may be used as a fixed value. Even in that case, the efficacy of the present invention where a predicted amount to be consumed of toner is supplied ahead of schedule and the fluctuation in the toner concentration within the development device is moderated will never become impaired.

Further, on the occasion of calculating the recent toner consumption, in this embodiment, the recent five pages of toner consumptions are averaged; however, this number of page may be other number.

Further, when the average toner consumption is calculated, it is designed in this embodiment to calculate all consumption up to the present; however, this may be simplified for the purpose of roughly averaged value. In this case, if the update value Tₐᵥₑ of the average toner consumption is calculated, for example, using the following expression,

(T_{old} ×0.9)+(T_{now}×0.1)

the calculated estimated consumption can be reflected to an update value of the average toner consumption.

Further, in this embodiment, for simplification, a monochromatic image forming device was described; however, it is also realizable with a multicolor image forming device by comprising this toner concentration controlling device independently per color.

With the toner concentration controlling device, the toner concentration controlling method and the toner concentration controlling program relating to the present invention, in an image forming device mainly using two-component development method of electrophotographic process, the fluctuation in the toner concentration within the device can be moderated by controlling the toner supply, and a predetermined quality can be maintained. In addition, the present invention is also applicable not only to the two-component development method but also to other image forming devices using a one-component development method or formation of visual images using other developer, such as powder or liquid.

1. A developer supply device for supplying a developer to a development device on the occasion of forming an image, with regard to an image forming device comprising the development device that consumes the developer and forms an image onto paper or other recording medium, comprising:
an image density counting means for counting image density of an image composed of multiple pixels per pixel;
a developer consumption estimation means for estimating a developer consumption, which is an amount of the developer to be consumed during the development of the image, based upon the counted number of the image counted by the image density counting means, for an entire surface or a part of image; and
a developer supply means for supplying to supplement a variable amount of developer to the development device; wherein
the developer supply means supplements the developer with an amount base upon the estimated developer consumption for a portion of one surface, in the formation of an image on said surface during the period of image formation on said surface.

2. The developer supply device according to claim 1, further comprising a developer amount controlling means for controlling the supply of a developer by the developer supply means, wherein
the developer controlling means controls so as to supply the developer by the developer supply means when the developer consumption estimated by the developer consumption estimation means exceeds a predetermined threshold value.

3. The developer supply device according to claim 2, wherein
the developer amount controlling means further controls a correction for correcting an amount of the developer supplied by the developer supply means so as to have the amount of the developer within the development device being a predetermined standard amount; obtains an aggregate value from the previous correction of the developer consumption estimated by the consumption estimating means every time the image formation for a portion of the one surface is completed and every time the formation on the one surface is completed; and controls the correction when the obtained aggregate value exceeds a predetermined threshold value.

4. A developer supply device supplying a developer to a development device on the occasion of forming an image, with regard to an image forming device comprising the development device that consumes the developer and forms an image onto paper or other recording medium, comprising:
an image density counting means for counting image density of an image composed of multiple pixels per pixel;
a developer consumption estimation means for estimating a developer consumption, which is an amount of the developer to be consumed during the development of the image, based upon the counted number of the image counted by the image density counting means, for an entire surface or a portion of image;
an average developer consumption calculating means for calculating an average value of the developer consumption during a predetermined period in the past and an average developer consumption, which is another average value; and
a developer supply means for supplementing a variable amount of developer to the development device; wherein
the developer supply means supplements a developer with an amount based upon the average developer consumption calculated by the average developer consumption calculating means to the development device during the period of image formation on one surface, and the supplement of the developer after the formation on one surface is supplied by adjusting a difference between the developer consumption estimated by the developer consumption estimation means and an already-supplemented amount.

5. The developer supply device according to claim 4, wherein
the average developer consumption calculating means calculates at least one of an average value of the developer estimated consumptions in the past estimated by developer consumption estimation means in the past image formation and an average value only during the predetermined recent period, as the average developer consumption.

6. The developer supply device according to claim 4, wherein
the average developer consumption calculating means acquires an average value of the past developer estimated consumption in the past image formation estimated by the developer consumption estimation means and an average value only during the predetermined recent period, and assesses the average developer consumption by varying a ratio to weight between each other according to the degree of fluctuation in these values, based upon the average values.

7. The developer supply device according to claim 1, wherein
the development device comprises a developer agitating means for agitating the developer; and
the developer supply means completes or stops its supplying operation in the supplement of the developer to the development device before a predetermined time for suspending the agitation by the developer agitating means.

8. The developer supply device according to claim 1, wherein the image density counting means counts the number of pixels to be developed.

9. The developer supply device according to claim 1, wherein the image density counting means performs weighting with a predetermined coefficient according to the pattern of alignment of multiple pixels relating to the development, and counts the image density.

10. The developer supply device according to claim 9, wherein the image density counting means counts the number of pixels to be developed and the number of pixels positioned at the end of a portion of an image where the pixels to be developed are continuously aligned, respectively.

11. The developer supply device according to claim 1, wherein the image density counting means counts the image density at the time or around the time of developing the pixels relating to the counting.

12. An image forming device comprising the developer supply device according to claim 1.

13. A developer supply control method of a developer supply for supplying a developer to a development device on the occasion of forming an image, with respect to an image forming device that comprises the development device to consume the developer and forms an image onto paper or other recording medium, comprising:
an image density counting step for counting the image density of an image composed of multiple pixels per pixel;
a developer consumption estimation step for estimating a developer consumption, which is an amount of developer to be consumed during the development of an image, based upon the counted value of the image counted in the image density counting step, for an image on one surface or a portion of the surface; and
a developer supply step for supplying to supplement a variable amount of developer to the development device, wherein
in the developer supplying step, the developer with an amount based upon the developer consumption estimated for a portion on one surface to the development device during a period of the image formation on the one surface in the image formation on one surface.

14. The developer supply control method according to claim 13, further comprising a developer amount controlling step for controlling the supply of the developer by the developer supply means, wherein
in the developer amount controlling step, when the developer consumption estimated in the developer consumption estimation step exceeds a predetermined threshold value, it is controlled to supply the developer in the developer supply step.

15. The developer supply control method according to claim 14, wherein
in the developer amount controlling step,
correction control for correcting an amount of developer to be supplied by the developer supply means is further conducted so as to have the amount of the development within the development device;
the aggregate value of the developer consumption from the previous correction estimated in the developer consumption estimation step is acquired every time the image formation on a portion of the surface is completed and every time the formation on the surface is completed; and
when the acquired aggregate value exceeds a predetermined threshold value, the correction control is conducted.

16. A developer supply control method of a developer supply for supplying a developer to the development device on the occasion of the image formation, with regard to an image formation device comprising the development device that consumes the developer and forms an image onto paper or other recording medium, comprising:
an image density counting step for counting the image density of an image composed of multiple pixels per pixel;
a developer consumption estimation step for estimating a developer consumption, which is an amount of the developer to be consumed during the development, based upon the counted value of the image counted by the image density counting means, for an image on one surface or an partial image;
an average developer consumption calculating step for calculating an average value of the developer consumption during the past predetermined period and an average developer consumption, which is another average value; and
a developer supply step for supplementing by supplying a variable amount of developer to the development device; wherein,
in the developer supplying step, a developer with an amount based upon the average developer consumption calculated by the average developer consumption calculating means is supplemented to the development device during the period of image formation on one surface, and the supplement of the developer after the formation on one surface is supplied by adjusting a difference between the developer consumption estimated by the developer consumption estimation means and an already-supplemented amount.

17. The developer supply control method according to claim 16, wherein
in the average developer consumption calculating step, regarding the developer estimated consumptions in the past estimated in the developer consumption estimation step in the past image formation, at least one of an average value of these values in the past and an average value only during the predetermined recent period among them is calculated as the average developer consumption.

18. The developer supply control method according to claim 16, wherein
in the average developer consumption calculating step, for development estimated consumption estimated by developer consumption estimation step in the past image formation, an average value of those consumptions in the past and an average value of those consumptions only during the predetermined recent period are acquired, and the average developer consumption is assessed by varying a ratio to weight between each other according to the degree of fluctuation in these values, based upon the average values.

19. The developer supply control method according to claim 13, wherein in the image density counting step, the image density is counted at the time or around the time of developing pixels relating to the counting.

20. A developer supply control program for having the developer supply device executing the procedures in the developer supply control method according to claim 13.
